(19) United States
(12) Patent Application Publication
(10) Pub. No.: US 2024/0396576 A1
(43) Pub. Date: Nov. 28, 2024

(54) ELECTRONIC DEVICE FOR PROVIDING SECURE CONNECTION AND OPERATING METHOD THEREOF

(71) Applicant: SAMSUNG ELECTRONICS CO., LTD., Suwon-si (KR)

(72) Inventors: Dongil YANG, Suwon-si (KR); Yohan Moon, Suwon-si (KR); Mincheol Kim, Suwon-si (KR); Seonjun Kim, Suwon-si (KR); Taeyoung Kim, Suwon-si (KR); Hyoseok Na, Suwon-si (KR); Jonghun Yoo, Suwon-si (KR)

(73) Assignee: SAMSUNG ELECTRONICS CO., LTD., Suwon-si (KR)

(21) Appl. No.: 18/675,999

(22) Filed: May 28, 2024

Related U.S. Application Data
(63) Continuation of application No. PCT/KR2024/007063, filed on May 24, 2024.

(30) Foreign Application Priority Data
May 25, 2023 (KR) 10-2023-0067440
Jun. 28, 2023 (KR) 10-2023-0083804

(51) Int. Cl. H04B 1/00; H01Q 1/22; H01Q 1/38; H04B 1/04

(52) U.S. Cl. CPC H04B 1/0078; H04B 1/0458; H01Q 1/2283; H01Q 1/38; H04B 2001/0408

(57) ABSTRACT

A method may include switching to a first mode based on identifying that a condition for activating the first mode for transmitting and receiving a signal in a first frequency band is satisfied, converting, using an RFIC in the first mode, data to be transmitted to an external electronic device into a first signal in a second frequency band, mixing the first signal with a second signal in a third frequency band using a first mixer in an RF circuit connected to the RFIC to generate a third signal in the first frequency band, and amplifying, using a PA in the RF circuit, the third signal based on a set gain to generate a fourth signal, and transmitting the fourth signal to the external electronic device using at least one antenna.

### CROSS-REFERENCE TO RELATED APPLICATIONS

This application is a continuation application of International Application No. PCT/KR2024/007063 designating the United States, filed on May 24, 2024, in the Korean Intellectual Property Receiving Office, which claims priority to Korean Patent Application No. 10-2023-0067440, filed on May 25, 2023, in the Korean Intellectual Property Office, and Korean Patent Application No. 10-2023-0083804, filed on Jun. 28, 2023, in the Korean Intellectual Property Office, the disclosures of which are incorporated by reference herein in their entireties.

### BACKGROUND

### 1. Technical Field

One or more embodiments of the disclosure relate to an electronic device providing a secure connection and an operating method thereof.

### 2. Description of Related Art

With the recent development of an information communication technology, various wireless communication technologies and various services have been developed. In particular, a Bluetooth scheme, for example, a Bluetooth low energy (BLE) scheme, which is one of short-range communication schemes, has been actively used, and in the BLE scheme, low-capacity data may be transmitted and/or received with low power in a 2.4 GHz band. Electronic devices using the BLE scheme may operate in an active mode during time when a connection operation, a data transmission operation, and/or a data reception operation between the electronic devices are performed, and may operate in a sleep mode during other times. So, power consumption of the electronic devices using the BLE scheme may be reduced compared to a case that a legacy Bluetooth scheme is used. Accordingly, the BLE scheme may be mainly used in electronic devices for which power supply is limited, such as a health care device, a sensor device, or a wearable device (e.g., earphones, smart watches, or smart glasses).

Further, in addition to the Bluetooth scheme, a wireless fidelity (Wi-Fi) scheme enabling a high-performance wireless communication based on a wireless local communication network (a wireless local access network (LAN)) has also been actively used. The Wi-Fi scheme may be a short-range communication scheme based on institute of electrical and electronics engineers (IEEE) 802.11, and use a 2.4 GHz band and a 5 GHz band.

Further, a 4^{th} generation (4G) mobile communication system may support various bands, and a B31 band among the various bands may be a 450 MHz band, and may be used for a communication for which a relatively high security level (e.g., a security level greater than or equal to a threshold security level) is required. An external electronic device supporting the B31 band may be generally implemented in a dongle form, and the external electronic device implemented in the dongle form may be used by being wirelessly coupled to an electronic device (e.g., a smart phone).

A communication between the external electronic device and the electronic device may be a communication based on a Bluetooth scheme and/or a Wi-Fi scheme. The external electronic device and the electronic device may each transmit and receive a signal of the B31 band (e.g., a signal whose security level is higher than or equal to the threshold security level) via an antenna. For the connection between the electronic device and the external electronic device, a user may execute an application capable of using the external electronic device in the electronic device to set up a connection between the electronic device and the external electronic device which is based on the Bluetooth scheme and/or the Wi-Fi scheme. The electronic device and the external electronic device may perform a communication based on the set-up connection.

If the electronic device transmits the signal of the B31 band whose security level is higher than or equal to the threshold security level to the external electronic device, even though the security level of the B31 band signal itself is higher than or equal to the threshold level, when the electronic device and the external electronic device perform a communication through a connection which is based on the Bluetooth scheme and/or the Wi-Fi scheme, security may be vulnerable due to antenna radiation. The communication in a form of the antenna radiation may have a vulnerability of the security such as an attack by a hacker, so it may not be suitable for transmission and reception of a signal for which security is important.

The above information may be provided as a background art for the purpose of aiding understanding of the disclosure. No claim or determination has been made as to whether any of the foregoing may be applied as prior art related to the disclosure.

### SUMMARY

According to one or more example embodiments, an electronic device may include at least one antenna, a radio frequency integrated circuit (RFIC), a radio frequency front end (RFFE) including a first power amplifier (PA) connected to the RFIC and the at least one antenna, a radio frequency (RF) circuit including a first mixer connected to the RFIC, and a second PA connected to the first mixer and the at least one antenna, at least one processor, and memory storing instructions.

According to one or more example embodiments, the instructions, when executed by the at least one processor, cause the electronic device to switch to a first mode based on identifying that a condition for activating the first mode for transmitting/receiving a signal in a first frequency band is satisfied.

According to one or more example embodiments, the instructions, when executed by the at least one processor, cause the electronic device to convert, using the RFIC in the first mode, first data to be transmitted to an external electronic device into a first signal in a second frequency band.

According to one or more example embodiments, the instructions, when executed by the at least one processor, cause the electronic device to mix the first signal with a second signal in a third frequency band using the first mixer to generate a third signal in the first frequency band.

According to one or more example embodiments, the instructions, when executed by the at least one processor, cause the electronic device to amplify, using the second PA, the third signal based on a first gain to generate a fourth signal, and transmit the fourth signal to the external electronic device using the at least one antenna.

According to one or more example embodiments, a method may include switching to a first mode based on identifying that a condition for activating the first mode for transmitting/receiving a signal in a first frequency band is satisfied.

According to one or more example embodiments, the method may include converting, using a radio frequency integrated circuit (RFIC) in the first mode, data to be transmitted to an external electronic device into a first signal in a second frequency band.

According to one or more example embodiments, the method may include mixing the first signal with a second signal in a third frequency band using a first mixer in a radio frequency (RF) circuit connected to the RFIC to generate a third signal in the first frequency band.

According to one or more example embodiments, the method may include amplifying, using a power amplifier (PA) in the RF circuit, the third signal based on a set gain to generate a fourth signal, and transmitting the fourth signal to the external electronic device using at least one antenna.

According to one or more example embodiments, a storage medium storing at least one computer-readable instruction may be provided.

According to one or more example embodiments, the at least one instruction, when executed by at least one processor of an electronic device, may cause the electronic device to perform at least one operation.

According to one or more example embodiments, the at least one operation may comprise switching to a first mode based on identifying that a condition for activating the first mode for transmitting/receiving a signal in a first frequency band is satisfied.

According to one or more example embodiments, the at least one operation may comprise converting, using a radio frequency integrated circuit (RFIC) in the first mode, data to be transmitted to an external electronic device into a first signal in a second frequency band.

According to one or more example embodiments, the at least one operation may comprise mixing the first signal with a second signal in a third frequency band using a first mixer in a radio frequency (RF) circuit connected to the RFIC to generate a third signal in the first frequency band.

According to one or more example embodiments, the at least one operation may comprise amplifying, using a power amplifier (PA) in the RF circuit, the third signal based on a set gain to generate a fourth signal, and transmitting the fourth signal to the external electronic device using at least one antenna.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to one or more embodiments;

FIG. 2 is a diagram for describing a security issue due to antenna radiation between an electronic device and an external electronic device according to one or more embodiments;

FIG. 3 is a diagram for describing coupling between an electronic device and an external electronic device according to one or more embodiments;

FIG. 4 is a diagram for describing a security issue due to antenna radiation between an electronic device and an external electronic device according to one or more embodiments;

FIG. 5 is a block diagram schematically illustrating an electronic device according to one or more embodiments;

FIG. 6 is a block diagram schematically illustrating an electronic device according to one or more embodiments;

FIG. 7 is a block diagram schematically illustrating an electronic device according to one or more embodiments;

FIG. 8 is a block diagram schematically illustrating an electronic device according to one or more embodiments; and

FIG. 9 is a flowchart illustrating an operating method of an electronic device according to one or more embodiments.

### DETAILED DESCRIPTION

Hereinafter, one or more embodiments of the disclosure will be described in detail with reference to the accompanying drawings. In the following description of one or more embodiments of the disclosure, a detailed description of relevant known functions or configurations incorporated herein will be omitted when it is determined that the description may make the subject matter of one or more embodiments of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

It should be noted that the technical terms used herein are only used to describe a specific embodiment, and are not intended to limit one or more embodiments of the disclosure. Alternatively, the technical terms used herein should be interpreted to have the same meaning as those commonly understood by a person skilled in the art to which the disclosure pertains, and should not be interpreted have excessively comprehensive or excessively restricted meanings unless particularly defined as other meanings. Alternatively, when the technical terms used herein are wrong technical terms that cannot correctly represent the idea of the disclosure, it should be appreciated that they are replaced by technical terms correctly understood by those skilled in the art. Alternatively, the general terms used in one or more embodiments of the disclosure should be interpreted as defined in dictionaries or interpreted in the context of the relevant part, and should not be interpreted to have excessively restricted meanings.

Alternatively, a singular expression used herein may include a plural expression unless they are definitely different in the context. As used herein, such an expression as “comprises” or “include”, or the like should not be interpreted to necessarily include all elements or all operations described in the specification, and should be interpreted to be allowed to exclude some of them or further include additional elements or operations.

Alternatively, the terms including an ordinal number, such as expressions “a first” and “a second” may be used to describe various elements, but the corresponding elements should not be limited by such terms. These terms are used merely to distinguish between one element and any other element. For example, a first element may be termed a second element, and similarly, a second element may be termed a first element without departing from the scope of the disclosure.

It should be understood that when an element is referred to as being “connected” or “coupled” to another element, it may be connected or coupled directly to the other element, or any other element may be interposer between them. In contrast, it should be understood that when an element is referred to as being “directly connected” or “directly coupled” to another element, there are no element interposed between them.

Hereinafter, one or more embodiments of the disclosure will be described in detail with reference to the accompanying drawings. Regardless of drawing signs, the same or like elements are provided with the same reference numeral, and a repeated description thereof will be omitted. Alternatively, in describing one or more embodiments of the disclosure, a detailed description of relevant known technologies will be omitted when it is determined that the description may make the subject matter of the disclosure unclear. Alternatively, it should be noted that the accompanying drawings are presented merely to help easy understanding of the technical idea of the disclosure, and should not be construed to limit the technical idea of the disclosure. The technical idea of the disclosure should be construed to cover all changes, equivalents, and alternatives, in addition to the drawings.

Hereinafter, an electronic device will be described in one or more embodiments of the disclosure, but the electronic device may be referred to as a terminal, a mobile station, a mobile equipment (ME), a user equipment (UE), a user terminal (UT), a subscriber station (SS), a wireless device, a handheld device, or an access terminal (AT). Alternatively, in one or more embodiments of the disclosure, the electronic device may be a device having a communication function such as, for example, a mobile phone, a personal digital assistant (PDA), a smart phone, a wireless MODEM, or a notebook.

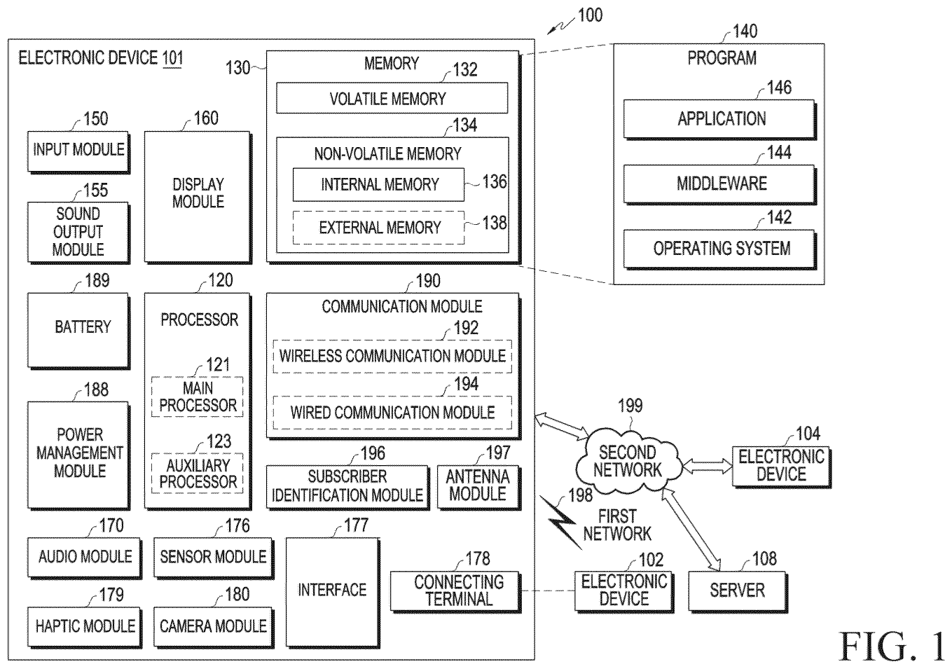

FIG. 1 is a block diagram illustrating an electronic device 101 in a network environment 100 according to an embodiment.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to a particular embodiment and include various changes, equivalents, or replacements for an embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

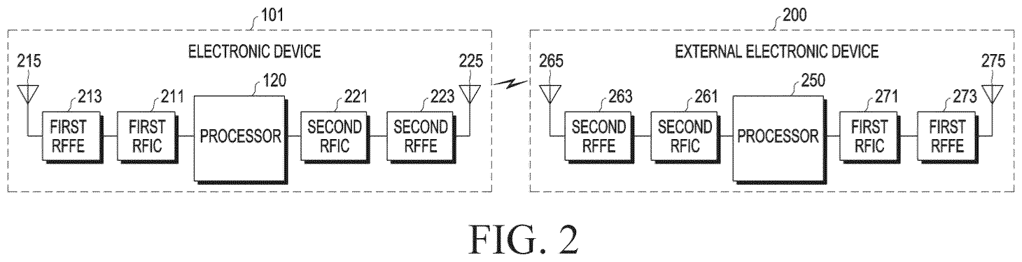

FIG. 2 is a diagram for describing a security issue due to antenna radiation between an electronic device and an external electronic device.

Referring to FIG. 2, an electronic device 101 (e.g., an electronic device 101 in FIG. 1) (e.g., a smart phone) may include a processor 120 (e.g., a processor 120 in FIG. 1), a first radio frequency integrated circuit (RFIC) 211, a first radio frequency front end (RFFE) 213, a first antenna 215, a second RFIC 221, a second RFFE 223, and/or a second antenna 225.

According to one or more embodiments, the processor 120 may include an application processor and/or a communication processor. According to one or more embodiments, the electronic device 101 may further include at least one component among components illustrated in FIG. 1. According to one or more embodiments, the first RFIC 211, the first RFFE 213, the second RFIC 221, and/or the second RFFE 223 may form at least a portion of a wireless communication module 192 in FIG. 1.

According to one or more embodiments, the (at least one) processor 120 may support establishment of a communication channel of a band to be used for a wireless communication with a cellular network (e.g., a second network 199 in FIG. 1) and a network communication through the established communication channel. According to one or more embodiments, the cellular network may include a 2^{nd} generation (2G) network, a 3^{rd} generation (3G) network, a 4^{th} generation (4G) network, and a long term evolution (LTE) network, and/or a 5^{th} generation (5G) network.

During transmission, the first RFIC 211 may convert a baseband signal generated by the processor 120 into an RF signal of a band (e.g., a band of about 700 MHz to about 3 GHz, or about 6 GHz or less) used in the cellular network. During reception, an RF signal may be received from the cellular network via the first antenna 215 and preprocessed via the first RFFE 213. The first RFIC 211 may convert the RF signal preprocessed via the first RFFE 213 into a baseband signal to be processed by the processor 120.

According to one or more embodiments, the first RFFE 213 may include a power amplifier (PA) and/or a low noise amplifier (LNA), and perform a power amplification operation and a filtering operation.

According to one or more embodiments, the processor 120 may support establishment of a communication channel of a band to be used for a wireless communication with a short-range communication network (e.g., a first network 198 in FIG. 1) and a network communication through the established communication channel. According to one or more embodiments, the short-range communication network may include a network which is based on a Bluetooth scheme (e.g., a Bluetooth low energy (BLE) scheme and/or a legacy Bluetooth scheme), and/or a wireless fidelity (Wi-Fi) scheme.

During transmission, the second RFIC 221 may convert a baseband signal generated by the processor 120 into an RF signal of a band (e.g., a 2.4 GHz band (e.g., a band used in a short-range communication network which is based on the Bluetooth scheme) and/or a 2.4 GHz band and a 5 GHz band (e.g., a band used in a short-range communication network which is based on the Wi-Fi scheme). During reception, an RF signal may be received from the short-range communication network via the second antenna 225 and preprocessed via the second RFFE 223. The second RFIC 221 may convert the RF signal preprocessed via the second RFFE 223 into a baseband signal to be processed by the processor 120.

An external electronic device 200 (e.g., an electronic device 102 in FIG. 1) (e.g., a dongle) may include a processor 250, a first RFIC 271, a first RFFE 273, a first antenna 275, a second RFIC 261, a second RFFE 263, and/or a second antenna 265.

According to one or more embodiments, the processor 250 may include an application processor and/or a communication processor. According to one or more embodiments, like the electronic device 101, the external electronic device 200 may further include at least one of components illustrated in FIG. 1.

According to one or more embodiments, the processor 250 may support establishment of a communication channel of a band to be used for a wireless communication with a cellular network (e.g., a second network 199 in FIG. 1) and a network communication through the established communication channel. According to one or more embodiments, the cellular network may include a 2G network, a 3G network, a 4G network, and an LTE network, and/or a 5G network.

During transmission, the first RFIC 271 may convert a baseband signal generated by the processor 250 into an RF signal of a band (e.g., a B31 band or 450 MHz) used in the cellular network. During reception, an RF signal may be received from the cellular network via the first antenna 275 and preprocessed via the first RFFE 273. The first RFIC 271 may convert the RF signal preprocessed via the first RFFE 273 into a baseband signal to be processed by the processor 250.

According to one or more embodiments, the first RFFE 273 may include a PA

and/or an LNA, and may perform a power amplification operation and a filtering operation.

According to one or more embodiments, the processor 250 may support establishment of a communication channel of a band to be used for a wireless communication with a short-range communication network (e.g., a first network 198 in FIG. 1) and a network communication through the established communication channel. According to one or more embodiments, the short-range communication network may include a network which is based on a Bluetooth scheme (e.g., a BLE scheme and/or a legacy Bluetooth scheme), and/or a Wi-Fi scheme.

During transmission, the second RFIC 261 may convert a baseband signal generated by the processor 250 into an RF signal of a band (e.g., a 2.4 GHz band (e.g., a band used in a short-range communication network which is based on the Bluetooth scheme) and/or a 2.4 GHz band and a 5 GHz band (e.g., a band used in a short-range communication network which is based on the Wi-Fi scheme). During reception, an RF signal may be received from the short-range communication network via the second antenna 265 and preprocessed via the second RFFE 263. The second RFIC 261 may convert the RF signal preprocessed via the second RFFE 263 into a baseband signal to be processed by the processor 250.

A 4G mobile communication system may support various bands, and a B31 band among the various bands may be a 450 MHz band, and may be used for a communication for which a relatively high security level (e.g., a security level greater than or equal to a threshold security level) is required. The external electronic device 200 supporting the B31 band may be generally implemented in a dongle form, and the external electronic device 200 implemented in the dongle form may be used by being wirelessly coupled to the electronic device 101.

A communication between the external electronic device 200 and the electronic device 101 may be a communication based on a Bluetooth scheme and/or a Wi-Fi scheme. The external electronic device 200 and the electronic device 101 may each transmit and receive a signal of the B31 band (e.g., a signal whose security level is higher than or equal to the threshold security level) via an antenna (e.g., the second antenna 265 in a case of the external electronic device 200 and the second antenna 225 in a case of the electronic device 101). For the connection between the electronic device 101 and the external electronic device 200, a user may execute an application capable of using the external electronic device 200 in the electronic device 101 to set up a connection between the electronic device 101 and the external electronic device 200 which is based on the Bluetooth scheme and/or the Wi-Fi scheme. The electronic device 101 and the external electronic device 200 may perform a communication based on the set-up connection.

If the electronic device 101 transmits the signal of the B31 band whose security level is higher than or equal to the threshold security level to the external electronic device 200, even though the security level of the B31 band signal itself is higher than or equal to the threshold level, when the electronic device 101 and the external electronic device 200 perform a communication through a connection which is based on the Bluetooth scheme and/or the Wi-Fi scheme, security may be vulnerable due to antenna radiation. The communication in a form of the antenna radiation may have a vulnerability of the security such as an attack by a hacker, so it may not be suitable for transmission and reception of a signal for which security is important.

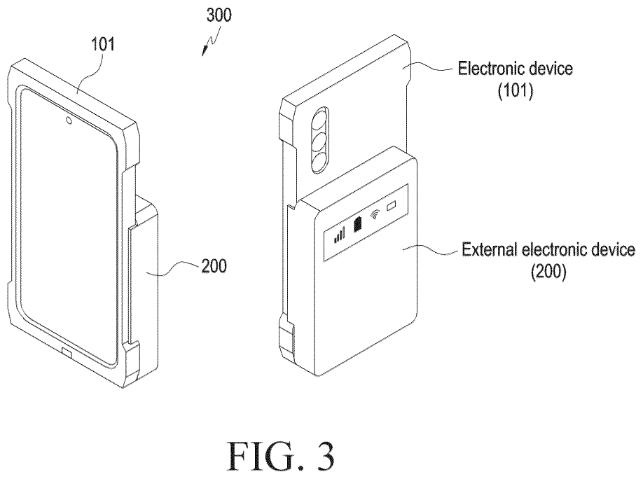

FIG. 3 is a diagram for describing coupling between an electronic device and an external electronic device.

Referring to FIG. 3, each of an electronic device 101 (e.g., an electronic device 101 in FIG. 1 or 2) (e.g., a smart phone) and an external electronic device 200 (e.g., an electronic device 102 in FIG. 1 or an external electronic device 200 in FIG. 2) (e.g., a dongle) may be an independently designed device. The independently designed electronic device 101 and external electronic device 200 may include a structure in which a housing of the electronic device 101 or a housing of the external electronic device 200 may be coupled (300). In one or more embodiments, portability of the electronic device 101 and the external electronic device 200 may be increased based on the structure in which the housing of the electronic device 101 or the housing of the external electronic device 200 may be coupled.

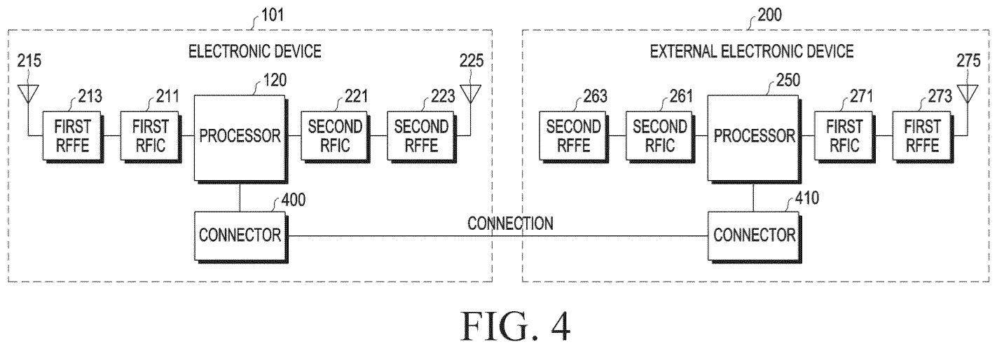

FIG. 4 is a diagram for describing a security issue due to antenna radiation

between an electronic device and an external electronic device.

Referring to FIG. 4, an electronic device 101 (e.g., an electronic device 101 in FIG. 1, 2, or 3) (e.g., a smart phone) may include a processor 120 (e.g., a processor 120 in FIG. 1 or 2), a first RFIC 211 (e.g., a first RFIC 211 in FIG. 2), a first RFFE 213 (e.g., a first RFFE 213 in FIG. 2), a first antenna 215 (e.g., a first antenna 215 in FIG. 2), a second RFIC 221 (e.g., a second RFIC 221 in FIG. 2), a second RFFE 223 (e.g., a second RFFE 223 in FIG. 2), a second antenna 225 (e.g., a second antenna 225 in FIG. 2), and/or a connector 400.

According to one or more embodiments, the processor 120 may include an application processor and/or a communication processor. According to one or more embodiments, the electronic device 101 may further include at least one component among components illustrated in FIG. 1. According to one or more embodiments, the first RFIC 211, the first RFFE 213, the second RFIC 221, and/or the second RFFE 223 may form at least a portion of a wireless communication module 192 in FIG. 1.

According to one or more embodiments, the processor 120 may support establishment of a communication channel of a band to be used for a wireless communication with a cellular network (e.g., a second network 199 in FIG. 1) and a network communication through the established communication channel.

During transmission, the first RFIC 211 may convert a baseband signal generated by the processor 120 into an RF signal of a band (e.g., a band of about 700 MHz to about 3 GHz, or about 6 GHz or less) used in the cellular network. During reception, an RF signal may be received from the cellular network via the first antenna 215 and preprocessed via the first RFFE 213. The first RFIC 211 may convert the RF signal preprocessed via the first RFFE 213 into a baseband signal to be processed by the processor 120.

According to one or more embodiments, the first RFFE 213 may include a PA and/or an LNA, and perform a power amplification operation and a filtering operation.

According to one or more embodiments, the processor 120 may support establishment of a communication channel of a band to be used for a wireless communication with a short-range communication network (e.g., a first network 198 in FIG. 1) and a network communication through the established communication channel. According to one or more embodiments, the short-range communication network may include a network which is based on a Bluetooth scheme (e.g., a BLE scheme and/or a legacy Bluetooth scheme), and/or a Wi-Fi scheme.

During transmission, the second RFIC 221 may convert a baseband signal generated by the processor 120 into an RF signal of a band (e.g., a 2.4 GHz band (e.g., a band used in a short-range communication network which is based on the Bluetooth scheme) and/or a 2.4 GHz band and a 5 GHz band and/or 6 GHz band (e.g., a band used in a short-range communication network which is based on the Wi-Fi scheme). In FIG. 4, a case that the band used in the short-range communication network based on the Bluetooth scheme is the 2.4 GHz band has been described as an example, however, the Bluetooth scheme may be implemented in a form of using various bands (e.g., the 5 GHz band and/or 6 GHz band) as well as the 2.4 GHz band.

During reception, an RF signal may be received from the short-range communication network via the second antenna 225 and preprocessed via the second RFFE 223. The second RFIC 221 may convert the RF signal preprocessed via the second RFFE 223 into a baseband signal to be processed by the processor 120.

According to one or more embodiments, the connector 400 may provide an electrical and/or operational connection between the electronic device 101 and an external electronic device 200 (e.g., an electronic device 102 in FIG. 1 or an external electronic device 200 in FIG. 2 or 3) (e.g., a dongle). The connector 400 may include at least one socket, and may be coupled to a connector 410 included in an external electronic device 200 to provide the electrical and/or operational connection. In one or more embodiments, the connector 400 may provide a physical connection between the electronic device 101 and the external electronic device 200. In one or more embodiments, the connector 400 may transmit and receive various signals for an interface between the electronic device 101 and the external electronic device 200.

In one or more embodiments, if the connector 400 includes at least one socket, the connector 410 may include at least one pin. In one or more embodiments, if the connector 400 includes at least one pin, the connector 410 may include at least one socket. In one or more embodiments, if the connector 400 includes two sockets and the connector 410 includes two pins, one socket of the connector 400 and one pin of the connector 410 may be used for a physical connection between the electronic device 101 and the external electronic device 200, and the other socket of the connector 400 and the other pin of the connector 410 may be used to transmit and receive various signals for an interface between the electronic device 101 and the external electronic device 200. In one or more embodiments, if the connector 400 includes two pins and the connector 410 includes two sockets, one pin of the connector 400 and one socket of the connector 410 may be used for the physical connection between the electronic device 101 and the external electronic device 200, and the other pin of the connector 400 and the other socket of the connector 410 may be used to transmit and receive the various signals for the interface between the electronic device 101 and the external electronic device 200. In FIG. 4, a case that the connector 400 includes the pin (or the socket) used to transmit and receive the various signals for the interface between the electronic device 101 and the external electronic device 200 has been described, however, the connector 400 may not include the pin (or the socket) used to transmit and receive the various signals for the interface between the electronic device 101 and the external electronic device 200. In this case, a separate connection part including a pin (or a socket) used to transmit and receive the various signals for the interface between the electronic device 101 and the external electronic device 200 may be implemented.

In one or more embodiments, the connector 400 may include various types of connectors such as an HDMI connector, a USB connector, an SD card connector, or an audio connector (e.g., a headphone connector).

The external electronic device 200 may include a processor 250 (e.g., a processor 250 in FIG. 2), a first RFIC 271 (e.g., a first RFIC 271 in FIG. 2), a first RFFE 273 (e.g., a first RFFE 273 in FIG. 2), a first antenna 275 (e.g., a first antenna 275 in FIG. 2), a second RFIC 261 (e.g., a second RFIC 261 in FIG. 2), a second RFFE 263 (e.g., a second RFFE 263 in FIG. 2), and/or the connector 410.

According to one or more embodiments, the processor 250 may include an application processor and/or a communication processor. According to one or more embodiments, like the electronic device 101, the external electronic device 200 may further include at least one of components illustrated in FIG. 1.

According to one or more embodiments, the processor 250 may support establishment of a communication channel of a band to be used for a wireless communication with a cellular network (e.g., a second network 199 in FIG. 1) and a network communication through the established communication channel. According to one or more embodiments, the cellular network may include a 2G network, a 3G network, a 4G network, and an LTE network, and/or a 5G network.

During transmission, the first RFIC 271 may convert a baseband signal generated by the processor 250 into an RF signal of a band (e.g., a B31 band or 450 MHZ) used in the cellular network. During reception, an RF signal may be received from the cellular network via the first antenna 275 and preprocessed via the first RFFE 273. The first RFIC 271 may convert the RF signal preprocessed via the first RFFE 273 into a baseband signal to be processed by the processor 250.

According to one or more embodiments, the first RFFE 273 may include a PA and/or an LNA, and may perform a power amplification operation and a filtering operation.

According to one or more embodiments, the processor 250 may support establishment of a communication channel of a band to be used for a wireless communication with a short-range communication network (e.g., a first network 198 in FIG. 1) and a network communication through the established communication channel. According to one or more embodiments, the short-range communication network may include a network which is based on a Bluetooth scheme (e.g., a BLE scheme and/or a legacy Bluetooth scheme), and/or a Wi-Fi scheme.

During transmission, the second RFIC 261 may convert a baseband signal generated by the processor 250 into an RF signal of a band (e.g., a 2.4 GHz band (e.g., a band used in a short-range communication network which is based on the Bluetooth scheme) and/or a 2.4 GHz band and a 5 GHz band and/or 6 GHz band (e.g., a band used in a short-range communication network which is based on the Wi-Fi scheme). During reception, an RF signal may be received from the electronic device 101 via the connector 410 and preprocessed via the second RFFE 263. The second RFIC 261 may convert the RF signal preprocessed via the second RFFE 263 into a baseband signal to be processed by the processor 250.

According to one or more embodiments, the connector 410 may provide an electrical and/or operational connection between the electronic device 101 and the external electronic device 200. The connector 410 may include at least one pin, and may be coupled to the connector 400 included in the electronic device 101 to provide the electrical and/or operational connection. In one or more embodiments, the connector 410 may provide a physical connection between the external electronic device 200 and the electronic device 101. In one or more embodiments, the connector 410 may transmit and receive various signals for an interface between the external electronic device 200 and the electronic device 101.

In one or more embodiments, if the connector 410 includes two sockets and the connector 400 includes two pins, one socket of the connector 410 and one pin of the connector 400 may be used for a physical connection between the external electronic device 200 and the electronic device 101, and the other socket of the connector 410 and the other pin of the connector 400 may be used to transmit and receive various signals for an interface between the external electronic device 200 and the electronic device 101. In one or more embodiments, if the connector 410 includes two pins and the connector 400 includes two sockets, one pin of the connector 410 and one socket of the connector 400 may be used for the physical connection between the external electronic device 200 and the electronic device 101, and the other pin of the connector 410 and the other socket of the connector 400 may be used to transmit and receive the various signals for the interface between the external electronic device 200 and the electronic device 101. In FIG. 4, a case that the connector 410 includes the pin (or the socket) used to transmit and receive the various signals for the interface between the external electronic device 200 and the electronic device 101 has been described, however, the connector 410 may not include the pin (or the socket) used to transmit and receive the various signals for the interface between the external electronic device 200 and the electronic device 101. In this case, a separate connection part including a pin (or a socket) used to transmit and receive the various signals for the interface between the external electronic device 200 and the electronic device 101 may be implemented.

In one or more embodiments, the connector 410 may include various types of connectors such as an HDMI connector, a USB connector, an SD card connector, or an audio connector (e.g., a headphone connector).

As described in FIG. 4, in the 4G mobile communication system, the external electronic device 200 supporting the B31 band used for a communication requiring a relatively high security level (e.g., a security level higher than a threshold security level) may be coupled to the electronic device 101 using connectors rather than being wirelessly coupled to the electronic device 101. In FIG. 4, the coupling of the electronic device 101 and the external electronic device 200 has been described by taking the 4G mobile communication system as an example of the mobile communication system, and by taking the B31 band as an example of the band used for the communication requiring the relatively high security level (e.g., the security level greater than or equal to the threshold security level), however, the coupling of the electronic device 101 and the external electronic device 200 according to the disclosure may be also applied to other communication systems as well as the 4G mobile communication system and to other bands as well as the B31 band.

If the connection between the external electronic device 200 and the electronic device 101 is a connection via the connectors, a security vulnerability such as an attack of a hacker which may occur due to antenna radiation may be reduced compared to a case that the connection between the external electronic device 200 and the electronic device 101 is a connection which is based on a Bluetooth scheme and/or a Wi-Fi scheme.

According to one or more embodiments, the electronic device 101 may transmit, to the external electronic device 200, a signal of the B31 band whose security level is higher than or equal to the threshold security level through the connection between the connectors, so a security level for the signal of the B31 band may be maintained.

However, the B31 band may be difficult to be supported in general electronic devices due to various reasons, such as a characteristic of a relatively low frequency band and limited usability. The reason is that in the B31 band, because a transmission frequency band of 452.5 MHz to 457.5 MHz is used and a reception frequency band of 462.5 MHz to 467.5 MHz is used, they are separated from transmission frequency bands and reception frequency bands used in other bands, so separate structures (e.g., an LNA) for the B31 band may be required inside the RFIC of the electronic device in order to support the transmission frequency band and reception frequency band used in the B31 band.

However, if the separate structures for the B31 band, such as the LNA, are included in the RFIC, most electronic devices which do not support the B31 band may suffer a loss in terms of cost, so it may be difficult for the RFIC to universally configure the B31 band. In addition, sizes of the structures to support the B31 band which is a relatively low frequency band are relatively large, so a size of the RFIC may also become large. So, the most electronic devices which do not support the B31 band may suffer a loss in terms of size, so it may be difficult for the RFIC to universally configure the B31 band.

So, it may be realistically difficult to support the B31 band in the RFIC, and therefore, an electronic device may support the B31 band using an external electronic device (e.g., a dongle) as described in FIGS. 2 and 4.

However, the B31 band is a band used for a communication for which a relatively high security level (for example, a security level higher than a threshold security level) is required, if the B31 band is supported using the external electronic device such as the dongle, two devices including the electronic device and the external electronic device are used, so there may be vulnerabilities in terms of security. Additionally, to support the B31 band, the electronic device is used as a main device and the external electronic device is used as a secondary device, so there may be a limitation in securing portability.

Accordingly, the disclosure may provide an electronic device capable of supporting a B31 band without using a separate external electronic device and an operating method thereof.

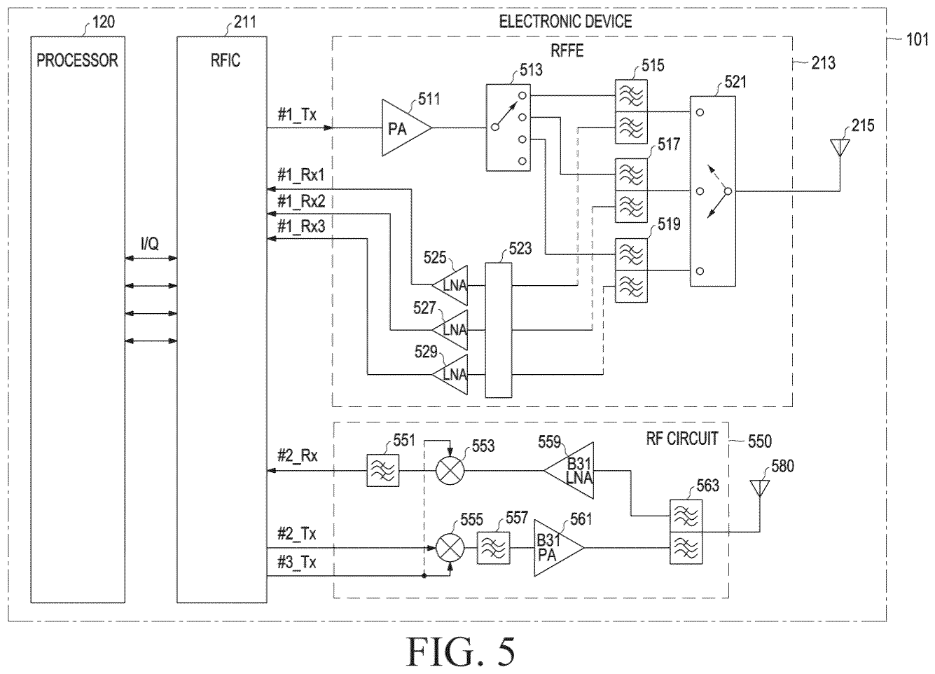

FIG. 5 is a block diagram schematically illustrating an electronic device according to one or more embodiments.

Referring to FIG. 5, an electronic device 101 (e.g., an electronic device 101 in FIG. 1, 2, 3, or 4) (e.g., a smart phone) may include a processor 120 (e.g., a processor 120 in FIG. 1, 2, or 4), an RFIC 211 (e.g., a first RFIC 211 in FIG. 2 or 4), an RFFE 213 (e.g., a first RFFE 213 in FIG. 2 or 4), a first antenna 215 (e.g., a first antenna 215 in FIG. 2 or 4), an RF circuit 550, and/or a second antenna 580. A case that the first antenna 215 and the second antenna 580 are implemented as separate antennas has been illustrated as one or more examples in FIG. 5, however, the first antenna 215 and the second antenna 580 may be implemented as one antenna. If the first antenna 215 and the second antenna 580 are implemented as the one antenna, a switch may exist between the RFFE 213 and the RF circuit 550, and if the RFFE 213 is used, the switch may operate such that the RFFE 213 may be connected to the antenna, and if the RF circuit 550 is used, the switch may operate such that the RF circuit 550 may be connected to the antenna. In this case, an operation of the switch may be controlled by the processor 120.

According to one or more embodiments, the RFFE 213 may be used for the remaining frequency bands (e.g., a fourth frequency band) excluding the first frequency band (e.g., the B31 band) among frequency bands used in a cellular network. In one or more embodiments, the first frequency band may be a frequency band ranging from about 450 MHz to 500 MHz For example, the B31 band may be a 450 MHz band.

According to one or more embodiments, the RF circuit 550 may be used for the first frequency band (e.g., the B31 band) among the frequency bands used in the cellular network.

According to one or more embodiments, the RFFE 213 may include a first PA 511, a first switch 513, a first duplexer 515, a second duplexer 517, a third duplexer 519, a second switch 521, a third switch 523, a first LNA 525, a second LNA 527, and/or a third LNA 529. In one or more embodiments, the first switch 513 may be used as a transmission switch, the second switch 521 may be used as an antenna switch, and the third switch 523 may be used as a reception switch.

According to one or more embodiments, the RF circuit 550 may include a first filter 551, a second mixer 553, a first mixer 555, a second filter 557, a fourth LNA 559, a second PA 561, and/or a fourth duplexer 563.

According to one or more embodiments, the processor 120 may include an application processor and/or a communication processor. According to one or more embodiments, the electronic device 101 may further include at least one component among components illustrated in FIG. 1. According to one or more embodiments, the RFIC 211, RFFE 213, and/or the RF circuit 550 may form at least a portion of a wireless communication module 192 in FIG. 1.

According to one or more embodiments, the processor 120 may support establishment of a communication channel in a band to be used for a wireless communication with a cellular network (e.g., a second network 199 in FIG. 1), and a network communication via the established communication channel.

According to one or more embodiments, the processor 120 may determine whether to activate the RFFE 213 or the RF circuit 550 based on various conditions. In one or more embodiments, if the RF circuit 550 is activated, the RFFE 213 may be deactivated. Alternatively, if the RFFE 213 is activated, the RF circuit 550 may be deactivated. In one or more embodiments, a mode in which the RF circuit 550 is activated, i.e., a mode in which the B31 band is activated, will be referred to as a “first mode,” and a mode in which the RFFE 213 is activated, i.e., a mode in which a frequency band other than the B31 band is activated, will be referred to as a “second mode”. In one or more embodiments, the first mode may be a mode for transmitting/receiving a signal in the first frequency band, and the second mode may be a mode for transmitting/receiving a signal in the fourth frequency band.

In one or more embodiments, a condition for activating the RF circuit 550 may be a condition under which a set application is executed. For example, if the set application is an application using the B31 band, the condition for activating the RF circuit 550 may be the condition under which the set application is executed.

In one or more embodiments, the condition for activating the RF circuit 550 may be a condition in which a set key (e.g., button) signal is inputted. For example, if the set key is a key indicating a user input indicating use of the B31 band, the condition for activating the RF circuit 550 may be a condition in which the set key signal is inputted.

In one or more embodiments, the RFIC 211, upon transmission, may convert a baseband signal generated by processor 120 into a signal in a band (e.g., a fourth frequency band) (e.g., a band from about 700 MHz to about 3 GHZ, or about 6 GHz or less) used in the cellular network. Alternatively, upon reception, the signal in the fourth frequency band may be received from the cellular network via the first antenna 215 and preprocessed via the RFFE 213. The RFIC 211 may convert the signal in the fourth frequency band preprocessed via the RFFE 213 into a baseband signal to be processed by the processor 120. In one or more embodiments, the fourth frequency band may be one of the remaining frequency bands (e.g., a first band, a second band, and/or a third band) excluding the band. For example, the first band may be an N1 band, the second band may be an N3 band, and the third band may be an N7 band.

In one or more embodiments, a case in which the electronic device 101 operates in the second mode will be described as follows.

In one or more embodiments, a transmitting operation in a case that the electronic device 101 operates in the second mode will be described as follows.

First, the RFIC 211 may convert a signal inputted from the processor 120 into a sixth signal (e.g., a transmission signal) in the fourth frequency band and transmit it to the first PA 511. For example, the signal inputted from the processor 120 may be a transmission signal (or second data) to be transmitted to an external electronic device (e.g., an electronic device 102 or an electronic device 104 in FIG. 1 or a server 108 in FIG. 1). In addition, the RFIC 211 may convert a signal (e.g., a received signal) in the fourth frequency band received from the first LNA 525, the second LNA 527, and/or the third LNA 529 into digital data which may be processed in the processor 120 and transmit the digital data to the processor 120.

The RFIC 211 may transfer the sixth signal to the first PA 511 via a first transmission pin, and the first PA 511 may amplify the sixth signal transferred from the RFIC 211 via the first transmission pin based on a set amplification gain (e.g., a first gain), and transfer the amplified signal to the first switch 513. In FIG. 5, the first transmission pin is marked as “#1_Tx”.

The first switch 513 may perform a switching operation so that the signal transferred from the first PA 511 is inputted to a corresponding duplexer based on the control of the processor 120. In one or more embodiments, it will be assumed that the processor 120 may support a total of three bands: the first band, the second band, and the third band, so the first switch 513 may transfer a signal corresponding to the first band to the first duplexer 515, transfer a signal corresponding to the second band to the second duplexer 517, and transfer a signal corresponding to the third band to the third duplexer 519, based on the control of the processor 120. In one or more embodiments, the signal transferred from the first switch 513 may be inputted to the first duplexer 515, and the first duplexer 515 may perform a duplex operation on the signal inputted from the first switch 513 to transfer it to the second switch 521.

In one or more embodiments, the signal transferred from the first switch 513 may be inputted to the second duplexer 517, and the second duplexer 517 may perform a duplex operation on the signal inputted from the first switch 513 to transfer it to the second switch 521.

In one or more embodiments, the signal transferred from the first switch 513 may be inputted to the third duplexer 519, and the third duplexer 519 may perform a duplex operation on the signal inputted from the first switch 513 to transfer it to the second switch 521.

In one or more embodiments, the second switch 521 may transmit, via the first antenna 215, one of the signal inputted from the first duplexer 515, the signal inputted from the second duplexer 517, or the signal inputted from the third duplexer 519 based on the control of the processor 120. In one or more embodiments, a receiving operation in a case that the electronic device 101 operates in the second mode will be described as follows.

First, a signal in the fourth frequency band received via the first antenna 215 may be inputted to the second switch 521, and the second switch 521 may perform a switching operation based on the control of the processor 120 so that the signal in the fourth frequency band received via the first antenna 215 is transferred to one of the first duplexer 515, the second duplexer 517, or the third duplexer 519.

In one or more embodiments, the signal transferred from the second switch 521 may be inputted to the first duplexer 515, and the first duplexer 515 may perform a duplex operation on the signal inputted from the second switch 521 to transfer it the third switch 523.

In one or more embodiments, the signal transferred from the second switch 521 may be inputted to the second duplexer 517, and the second duplexer 517 may perform a duplex operation on the signal inputted from the second switch 521 and transfer it to the third switch 523.

In one or more embodiments, the signal transferred from the second switch 521 may be inputted to the third duplexer 519, and the third duplexer 519 may perform a duplex operation on the signal inputted from the second switch 521 and transfer it to the third switch 523.

In one or more embodiments, the third switch 523 may transfer the signal inputted from the first duplexer 515 to the first LNA 525 based on the control of the processor 120. The signal transferred from the third switch 523 may be inputted to the first LNA 525, and the first LNA 525 may perform a low-noise amplification operation on the signal inputted from the third switch 523 based on a set amplification gain, and transfer the amplified signal to the RFIC 211.

In one or more embodiments, the third switch 523 may transfer the signal inputted from the second duplexer 517 to the second LNA 527 based on the control of the processor 120. The signal transferred from the third switch 523 may be inputted to the second LNA 527, and the second LNA 527 may perform a low-noise amplification operation on the signal inputted from the third switch 523 based on a set amplification gain and transfer the amplified signal to the RFIC 211.

In one or more embodiments, the third switch 523 may transfer the signal inputted from the third duplexer 519 to the third LNA 529 based on the control of the processor 120. The signal transferred from the third switch 523 may be inputted to the third LNA 529, and the third LNA 529 may perform a low-noise amplification operation on the signal inputted from the third switch 523 based on a set amplification gain and transfer the amplified signal to the RFIC 211.

In one or more embodiments, the signal transferred from the first LNA 525 may be inputted to the RFIC 211 via the first reception pin, the signal transferred from the second LNA 527 may be inputted to the RFIC 211 via the second reception pin, and the signal transferred from the third LNA 529 may be inputted to the RFIC 211 via the third reception pin. In FIG. 5, the first reception pin is marked as “#1_Rx1”, the second reception pin is marked as “#1_Rx2”, and the third reception pin is marked as “#1_Rx3”.

In one or more embodiments, a case in which the electronic device 101 operates in the first mode will be described as follows.

In one or more embodiments, a transmitting operation in a case that the electronic device 101 operates in the first mode will be described as follows.

First, the RFIC 211 may convert a signal inputted from the processor 120 into a first signal (e.g., a transmission signal) in the second frequency band and transmit it to the first mixer 555. For example, the signal inputted from the processor 120 may be a transmission signal (e.g., first data) to be transmitted to an external electronic device (e.g., an electronic device 102 or an electronic device 104 in FIG. 1, or a server 108 in FIG. 1). In addition, the RFIC 211 may convert a fifth signal (e.g., a received signal) in the second frequency band received from the first filter 551 into digital data which may be processed in the processor 120 and transfer it to the processor 120.

The RFIC 211 may transfer the first signal in the second frequency band to the first mixer 555 via the second transmission pin, and transfer, to the first mixer 555 via the third transmission pin, a second signal in the third frequency band for the second mixer 553 and the first mixer 555 which operate as a local oscillator (LO). In one or more embodiments, the second frequency band may be a frequency band ranging from about 1.8 GHz to 2.2 GHz. For example, the second frequency band may be a 2.1 GHz band. In one or more embodiments, the second signal in the third frequency band may be an LO frequency signal used in the first mixer 555 and may have a continuous wave (CW) form. In one or more embodiments, the third frequency band may be a frequency band ranging from about 1.5 GHZ to 18 GHz. For example, the third frequency band may be a 1.65 GHz band. In FIG. 5, the second transmission pin is marked as “#2_Tx”, and the third transmission pin is marked as “#3_Tx”.

In one or more embodiments, the first mixer 555 may mix the first signal in the second frequency band transferred from the RFIC 211 with the second signal in the third frequency band transferred from the RFIC 211 to generate a third signal in the first frequency band, and transfer the generated third signal to the second filter 557. The third signal may be a frequency signal corresponding to a 450 MHz band, which is the B31 band.

The third signal transferred from the first mixer 555 may be inputted to the second filter 557, and the second filter 557 may perform a filtering operation on the third signal inputted from the first mixer 555 to generate a filtered signal and transfer the filtered signal to the second PA 561.

The signal transferred from the second filter 557 may be inputted to the second PA 561, and the second PA 561 may amplify the signal inputted from the second filter 557 based on a set amplification gain (e.g., a first gain) to transfer an amplified signal to the fourth duplexer 563.

The signal transferred from the second PA 561 may be inputted to the fourth duplexer 563, and the fourth duplexer 563 may perform a duplex operation on the signal inputted from the second PA 561 to transfer it to the second antenna 580. A signal transferred from the fourth duplexer 563 may be transmitted via the second antenna 580.

In one or more embodiments, a reception operation in a case that the electronic device 101 operates in the first mode will be described as follows.

For example, the fourth signal in the first frequency band received via the second antenna 580 may be transferred to the fourth duplexer 563. The fourth signal received via the second antenna 580 may be inputted to the fourth duplexer 563, and the fourth duplexer 563 may perform a duplex operation on the inputted fourth signal to transfer it to the fourth LNA 559.

The fourth signal transferred from the fourth duplexer 563 may be inputted to the fourth LNA 559, and the fourth LNA 559 may perform a low-noise amplification operation on the fourth signal inputted from the fourth duplexer 563 based on an amplification gain set and then transfer an amplified signal to the second mixer 553.

The second mixer 553 may mix the second signal in the third frequency band transferred from the RFIC 211 with the fourth signal transferred from the fourth LNA 559 to generate a fifth signal in the second frequency band, and transfer the generated fifth signal to the first filter 551.

The fifth signal transferred from the second mixer 553 may be inputted to the first filter 551, and the first filter 551 may perform a filtering operation on the fifth signal inputted from the second mixer 553 to generate a filtered signal, and transfer the generated filtered signal to the RFIC 211.

In one or more embodiments, the signal transferred from the first filter 551 may be inputted to the RFIC 211 via the fourth reception pin. In FIG. 5, the fourth reception pin is marked as “#2_Rx”

A case that the first signal is a signal corresponding to the 2.1 GHz band and the second signal is a frequency signal corresponding to the 1.65 GHz band has been described as one or more examples in FIG. 5, however, a frequency band corresponding to the first signal may not necessarily need to be the 2.1 GHz band, and a frequency band corresponding to the second signal may not necessarily need to be the 1.65 GHz band. In the first frequency band (e.g., a B31 band), a frequency band of 452.5 MHz to 457.5 MHz is used as a transmission frequency band and a frequency band of 462.5 MHz to 467.5 MHz is used as a reception frequency band, so a frequency signal corresponding to any frequency band may be used as the first signal and the second signal if only a transmission frequency band in the B31 band may be generated.

As described in FIG. 5, the electronic device 101 may support the B31 band based on a first RF signal (e.g., the first signal) and a second RF signal (e.g., the second signal) without using a separate external electronic device, so an improvement may be achieved in terms of securing portability and security.

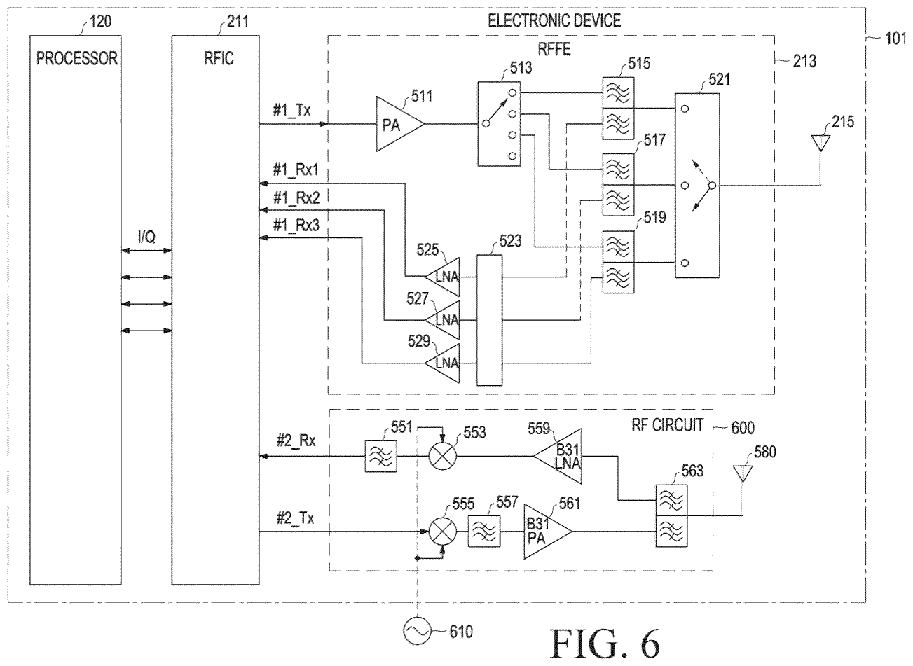

FIG. 6 is a block diagram schematically illustrating an electronic device according to one or more embodiments.

Referring to FIG. 6, an electronic device 101 (e.g., an electronic device 101 in FIG. 1, 2, 3, or 4) (e.g., a smart phone) may include a processor 120 (e.g., a processor 120 in FIG. 1, 2, or 4), an RFIC 211 (e.g., a first RFIC 211 in FIG. 2 or 4), an RFFE 213 (e.g., a first RFFE 213 in FIG. 2 or 4), a first antenna 215 (e.g., a first antenna 215 in FIG. 2 or 4), an RF circuit 600, and/or a second antenna 580. A case that the first antenna 215 and the second antenna 580 are implemented as separate antennas has been illustrated as one or more examples in FIG. 6, however, the first antenna 215 and the second antenna 580 may be implemented as one antenna. If the first antenna 215 and the second antenna 580 are implemented as the one antenna, a switch may exist between the RFFE 213 and the RF circuit 600, and if the RFFE 213 is used, the switch may operate such that the RFFE 213 may be connected to the antenna, and if the RF circuit 600 is used, the switch may operate such that the RF circuit 600 may be connected to the antenna. In this case, an operation of the switch may be controlled by the processor 120.

According to one or more embodiments, the RFFE 213 may be used for the remaining frequency bands (e.g., a fourth frequency band) excluding the first frequency band (e.g., the B31 band) among frequency bands used in a cellular network. In one or more embodiments, the first frequency band may be a frequency band ranging from about 450 MHz to 500 MHz For example, the B31 band may be a 450 MHz band.

According to one or more embodiments, the RF circuit 600 may be used for the first frequency band (e.g., the B31 band) among the frequency bands used in the cellular network.

According to one or more embodiments, the RFFE 213 may include a first PA 511, a first switch 513, a first duplexer 515, a second duplexer 517, a third duplexer 519, a second switch 521, a third switch 523, a first LNA 525, a second LNA 527, and/or a third LNA 529. The RFFE 213 may be implemented similarly to or substantially the same as an RFFE 213 described in FIG. 5, so a detailed description thereof will be omitted herein.

According to one or more embodiments, the RF circuit 600 may include a first filter 551, a second mixer 553, a first mixer 555, a second filter 557, a fourth LNA 559, a second PA 561, a fourth duplexer 563, and/or an LO 610.

According to one or more embodiments, the processor 120 may include an application processor and/or a communication processor. According to one or more embodiments, the electronic device 101 may further include at least one component among components illustrated in FIG. 1. According to one or more embodiments, the RFIC 211, the RFFE 213, and/or the RF circuit 600 may form at least a portion of a wireless communication module 192 in FIG. 1.

According to one or more embodiments, the processor 120 may determine whether to activate the RFFE 213 or the RF circuit 600 based on various conditions. In one or more embodiments, if the RF circuit 600 is activated, the RFFE 213 may be deactivated. Alternatively, if the RFFE 213 is activated, the RF circuit 600 may be deactivated. In one or more embodiments, a mode in which the RF circuit 600 is activated, i.e., a mode in which the B31 band is activated, will be referred to as a “first mode,” and a mode in which the RFFE 213 is activated, i.e., a mode in which a frequency band other than the B31 band is activated, will be referred to as a “second mode”. In one or more embodiments, the first mode may be a mode for transmitting/receiving a signal in the first frequency band, and the second mode may be a mode for transmitting/receiving a signal in the fourth frequency band.

According to one or more embodiments, the processor 120 may be implemented similarly to or substantially the same as a processor 120 described in FIG. 5, so a detailed description thereof will be omitted herein. In FIG. 6, a transmitting operation and a receiving operation in a case that the electronic device 101 operates in a second mode be implemented similarly to or substantially the same as a transmitting operation and a receiving operation in a case that an electronic device 101 operates in a second mode described in FIG. 5, so a detailed description thereof will be omitted herein.

In one or more embodiments, a case in which the electronic device 101 operates in the first mode will be described as follows.

In one or more embodiments, a transmitting operation in a case that the electronic device 101 operates in the first mode will be described as follows.

First, the RFIC 211 may convert a signal inputted from the processor 120 into a first signal (e.g., a transmission signal) in the second frequency band and transmit it to the first mixer 555. For example, the signal inputted from the processor 120 may be a transmission signal (e.g., first data) to be transmitted to an external electronic device (e.g., an electronic device 102 or an electronic device 104 in FIG. 1, or a server 108 in FIG. 1). In addition, the RFIC 211 may convert a fifth signal (e.g., a received signal) in the second frequency band received from the first filter 551 into digital data which may be processed in the processor 120 and transfer it to the processor 120.

The RFIC 211 may transfer the first signal in the second frequency band to the first mixer 555 via the second transmission pin. In one or more embodiments, the second frequency band may be a frequency band ranging from about 1.8 GHz to 2.2 GHZ. For example, the second frequency band may be a 2.1 GHz band. In FIG. 6, the second transmission pin is marked as “#2_Tx”.

In one or more embodiments, an LO 610 may transfer a second signal in the third frequency band to the first mixer 555. In one or more embodiments, the second signal in the third frequency band may be an LO frequency signal used in the first mixer 555 and may have a continuous wave (CW) form. In one or more embodiments, the third frequency band may be a frequency band ranging from about 1.5 GHz to 18 GHz. For example, the third frequency band may be a 1.65 GHz band.

In FIG. 5, a second signal is provided from the RFIC 211, but in FIG. 6, the second signal may be provided from the LO 610, which is a separate LO outside the RFIC 211, and a structure of the electronic device 101 illustrated in FIG. 6 may be different from a structure of an electronic device 101 illustrated in FIG. 5 due to the addition of the LO 610.

In one or more embodiments, the first mixer 555 may mix the first signal in the second frequency band transferred from the RFIC 211 with the second signal in the third frequency band transferred from the LO 610 to generate a third signal in the first frequency band, and transfer the generated third signal to the second filter 557. The third signal may be a frequency signal corresponding to a 450 MHz band, which is the B31 band.

The third signal transferred from the first mixer 555 may be inputted to the second filter 557, and the second filter 557 may perform a filtering operation on the third signal inputted from the first mixer 555 to generate a filtered signal and transfer the filtered signal to the second PA 561.

The signal transferred from the second filter 557 may be inputted to the second PA 561, and the second PA 561 may amplify the signal inputted from the second filter 557 based on a set amplification gain (e.g., a first gain) to transfer an amplified signal to the fourth duplexer 563.

The signal transferred from the second PA 561 may be inputted to the fourth duplexer 563, and the fourth duplexer 563 may perform a duplex operation on the signal inputted from the second PA 561 to transfer it to the second antenna 580. A signal transferred from the fourth duplexer 563 may be transmitted via the second antenna 580. In one or more embodiments, a reception operation in a case that the electronic

device 101 operates in the first mode will be described as follows.

The fourth signal in the first frequency band received via the second antenna 580 may be transferred to the fourth duplexer 563. The fourth signal transferred from the second antenna 580 may be inputted to the fourth duplexer 563, and the fourth duplexer 563 may perform a duplex operation on the inputted fourth signal to transfer it to the fourth LNA 559.

The fourth signal transferred from the fourth duplexer 563 may be inputted to the fourth LNA 559, and the fourth LNA 559 may perform a low-noise amplification operation on the fourth signal inputted from the fourth duplexer 563 based on an amplification gain set and then transfer an amplified signal to the second mixer 553.

The second mixer 553 may mix the second signal in the third frequency band transferred from the LO 610 with the fourth signal transferred from the fourth LNA 559 to generate a fifth signal in the second frequency band, and transfer the generated fifth signal to the first filter 551. In FIG. 5, a second RF signal (e.g., a second signal) is provided from the RFIC 211, but in FIG. 6, the second RF signal (e.g., the second signal) may be provided from the LO 610, which is a separate LO outside the RFIC 211, and a structure of the electronic device 101 illustrated in FIG. 6 may be different from a structure of an electronic device 101 illustrated in FIG. 5 due to the addition of the LO 610.

The fifth signal transferred from the second mixer 553 may be inputted to the first filter 551, and the first filter 551 may perform a filtering operation on the fifth signal inputted from the second mixer 553 to generate a filtered signal, and transfer the generated filtered signal to the RFIC 211.

In one or more embodiments, the signal transferred from the first filter 551 may be inputted to the RFIC 211 via the fourth reception pin. In FIG. 6, the fourth reception pin is marked as “#2_Rx”.

A case that the first signal is a signal corresponding to the 2.1 GHz band and the second signal is a frequency signal corresponding to the 1.65 GHz band has been described as one or more examples in FIG. 6, however, a frequency band corresponding to the first signal may not necessarily need to be the 2.1 GHz band, and a frequency band corresponding to the second signal may not necessarily need to be the 1.65 GHz band. In the first frequency band (e.g., a B31 band), a frequency band of 452.5 MHz to 457.5 MHz is used as a transmission frequency band and a frequency band of 462.5 MHz to 467.5 MHz is used as a reception frequency band, so a frequency signal corresponding to any frequency band may be used as the first signal and the second signal if only a transmission frequency band in the B31 band may be generated.

As described in FIG. 6, the electronic device 101 may support the B31 band based on the first RF signal and the second RF signal without using a separate external electronic device, so an improvement may be achieved in terms of securing portability and security.

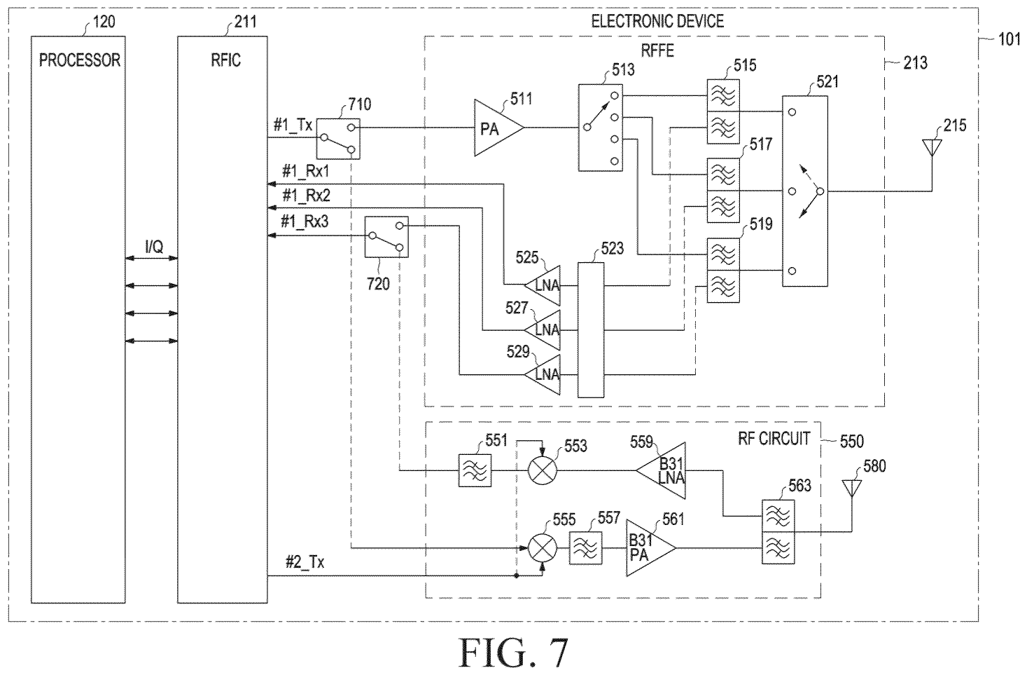

FIG. 7 is a block diagram schematically illustrating an electronic device according to one or more embodiments.

Referring to FIG. 7, an electronic device 101 (e.g., an electronic device 101 in FIG. 1, 2, 3, or 4) (e.g., a smart phone) may include a processor 120 (e.g., a processor 120 in FIG. 1, 2, or 4), an RFIC 211 (e.g., a first RFIC 211 in FIG. 2 or 4), an RFFE 213 (e.g., a first RFFE 213 in FIG. 2 or 4), a first antenna 215 (e.g., a first antenna 215 in FIG. 2 or 4), an RF circuit 550, a second antenna 580, a fourth switch 710, and/or a fifth switch 720. A case that the first antenna 215 and the second antenna 580 are implemented as separate antennas has been illustrated as one or more examples in FIG. 7, however, the first antenna 215 and the second antenna 580 may be implemented as one antenna. If the first antenna 215 and the second antenna 580 are implemented as the one antenna, a switch may exist between the RFFE 213 and the RF circuit 550, and if the RFFE 213 is used, the switch may operate such that the RFFE 213 may be connected to the antenna, and if the RF circuit 550 is used, the switch may operate such that the RF circuit 550 may be connected to the antenna. In this case, an operation of the switch may be controlled by the processor 120.

According to one or more embodiments, the RFFE 213 may be used for the remaining frequency bands (e.g., a fourth frequency band) excluding the first frequency band (e.g., the B31 band) among frequency bands used in a cellular network. In one or more embodiments, the first frequency band may be a frequency band ranging from about 450 MHz to 500 MHz For example, the B31 band may be a 450 MHz band.

According to one or more embodiments, the RF circuit 550 may be used for the first frequency band (e.g., the B31 band) among the frequency bands used in the cellular network.

According to one or more embodiments, the RFFE 213 may include a first PA 511, a first switch 513, a first duplexer 515, a second duplexer 517, a third duplexer 519, a second switch 521, a third switch 523, a first LNA 525, a second LNA 527, and/or a third LNA 529. In one or more embodiments, the first switch 513 may be used as a transmission switch, the second switch 521 may be used as an antenna switch, and the third switch 523 may be used as a reception switch. The RFFE 213 may be implemented similarly to or substantially the same as an RFFE 213 described in FIG. 5, so a detailed description thereof will be omitted herein.

According to one or more embodiments, the RF circuit 550 may include a first filter 551, a second mixer 553, a first mixer 555, a second filter 557, a fourth LNA 559, a second PA 561, and/or a fourth duplexer 563. The RF circuit 550 may be implemented similarly to or substantially the same as an RF circuit 550 described in FIG. 5, so a detailed description thereof will be omitted herein.

According to one or more embodiments, the processor 120 may include an application processor and/or a communication processor. r. According to one or more embodiments, the electronic device 101 may further include at least one component among components illustrated in FIG. 1. According to one or more embodiments, the RFIC 211, the RFFE 213, and/or the RF circuit 550 may form at least a portion of a wireless communication module 192 in FIG. 1.

According to one or more embodiments, the processor 120 may be implemented similarly to or substantially the same as a processor 120 described in FIG. 5, so a detailed description thereof will be omitted herein. In FIG. 7, a transmitting operation and a receiving operation in a case that the electronic device 101 operates in a second mode be implemented similarly to or substantially the same as a transmitting operation and a receiving operation in a case that an electronic device 101 operates in a second mode described in FIG. 5, so a detailed description thereof will be omitted herein. In FIG. 7, a transmitting operation and a receiving operation in a case that the electronic device 101 operates in a first mode be implemented similarly to or substantially the same as a transmitting operation and a receiving operation in a case that an electronic device 101 operates in a first mode described in FIG. 5, so a detailed description thereof will be omitted herein.

A structure of the electronic device 101 illustrated in FIG. 7 may be different from a structure of an electronic device 101 illustrated in FIG. 5 only in that it additionally includes the fourth switch 710 and/or the fifth switch 720, and this will be described in detail as follows.

In a case of the RFIC 211, the number of pins which may be supported may be limited. However, the electronic device 101 is evolving into a structure which supports multi-band, so a case may occur that the number of pins which may be supported in the RFIC 211 is insufficient. Therefore, FIG. 7 proposes a structure in which the RFFE 213 and the RF circuit 550 may share the pins of the RFIC 211.

In one or more embodiments, the fourth switch 710 and the fifth switch 720 may perform a switching operation under the control of the processor 120.

In one or more embodiments, the fourth switch 710 may be a switch used for sharing a first transmission pin (e.g., #1_Tx), and may perform a switching operation so that a signal in the fourth frequency band is transferred to the first PA 511, or perform a switching operation so that a first signal in the second frequency band is transferred to the first mixer 555, under the control of the processor 120.

In one or more embodiments, the fifth switch 720 may be a switch used for sharing a third reception pin (e.g., #1_Rx3), and may perform a switching operation so that the signal transferred from the third LNA 529 is inputted to the RFIC 211, or perform a switching operation so that the signal transferred from the first filter 551 is inputted to the RFIC 211, under the control of the processor 120.

A case that a third transmission pin (e.g., #2_Tx) of the RFIC 211 is used exclusively for transferring the second signal has been illustrated in FIG. 7, however, the third transmission pin may also be shared for other purposes.

A case that the first signal is a signal corresponding to the 2.1 GHz band and

the second signal is a frequency signal corresponding to the 1.65 GHz band has been described as one or more examples in FIG. 7, however, a frequency band corresponding to the first signal may not necessarily need to be the 2.1 GHz band, and a frequency band corresponding to the second signal may not necessarily need to be the 1.65 GHz band. In the first frequency band (e.g., a B31 band), a frequency band of 452.5 MHz to 457.5 MHz is used as a transmission frequency band and a frequency band of 462.5 MHz to 467.5 MHz is used as a reception frequency band, so a frequency signal corresponding to any frequency band may be used as the first signal and the second signal if only a transmission frequency band in the B31 band may be generated.

As described in FIG. 7, the electronic device 101 may support the B31 band based on the first RF signal (e.g., the first signal) and the second RF signal (e.g., the second signal) without using a separate external electronic device, so an improvement may be achieved in terms of securing portability and security.

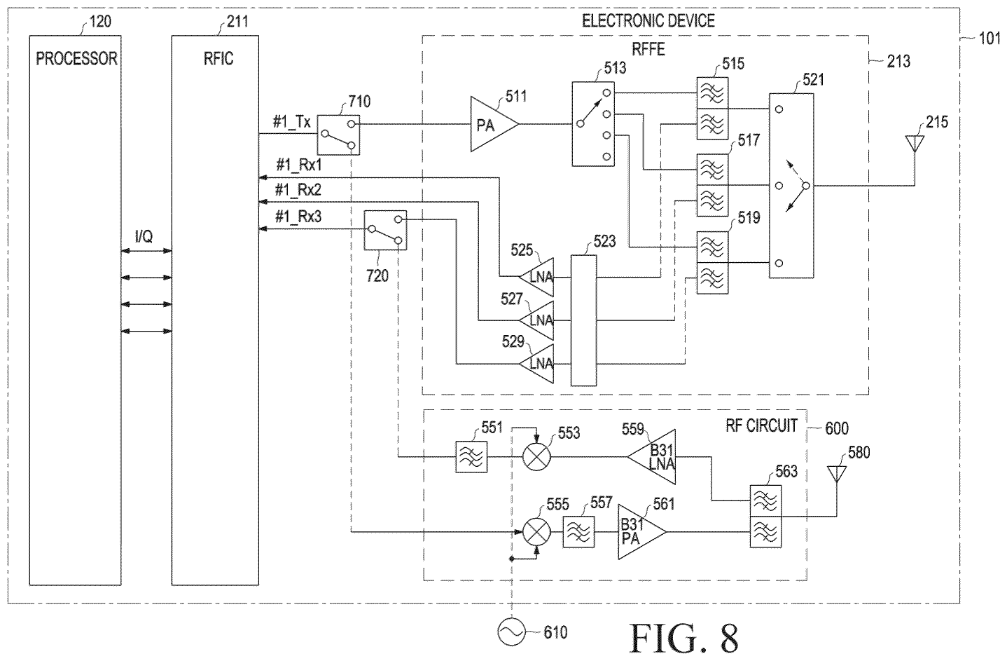

FIG. 8 is a block diagram schematically illustrating an electronic device according to one or more embodiments.

Referring to FIG. 8, an electronic device 101 (e.g., an electronic device 101 in FIG. 1, 2, 3, or 4) (e.g., a smart phone) may include a processor 120 (e.g., a processor 120 in

FIG. 1, 2, or 4), an RFIC 211 (e.g., a first RFIC 211 in FIG. 2 or 4), an RFFE 213 (e.g., a first RFFE 213 in FIG. 2 or 4), a first antenna 215 (e.g., a first antenna 215 in FIG. 2 or 4), an RF circuit 600, a second antenna 580, a fourth switch 710, and/or a fifth switch 720. A case that the first antenna 215 and the second antenna 580 are implemented as separate antennas has been illustrated as one or more examples in FIG. 8, however, the first antenna 215 and the second antenna 580 may be implemented as one antenna. If the first antenna 215 and the second antenna 580 are implemented as the one antenna, a switch may exist between the RFFE 213 and the RF circuit 600, and if the RFFE 213 is used, the switch may operate such that the RFFE 213 may be connected to the antenna, and if the RF circuit 600 is used, the switch may operate such that the RF circuit 600 may be connected to the antenna. In this case, an operation of the switch may be controlled by the processor 120.

According to one or more embodiments, the RFFE 213 may be used for the remaining frequency bands (e.g., a fourth frequency band) excluding the first frequency band (e.g., the B31 band) among frequency bands used in a cellular network. In one or more embodiments, the first frequency band may be a frequency band ranging from about 450 MHz to 500 MHz. For example, the B31 band may be a 450 MHz band.

According to one or more embodiments, the RF circuit 600 may be used for the first frequency band (e.g., the B31 band) among the frequency bands used in the cellular network.

According to one or more embodiments, the RFFE 213 may include a first PA 511, a first switch 513, a first duplexer 515, a second duplexer 517, a third duplexer 519, a second switch 521, a third switch 523, a first LNA 525, a second LNA 527, and/or a third LNA 529. The RFFE 213 may be implemented similarly to or substantially the same as an RFFE 213 described in FIG. 5, so a detailed description thereof will be omitted herein.

According to one or more embodiments, the RF circuit 600 may include a first filter 551, a second mixer 553, a first mixer 555, a second filter 557, a fourth LNA 559, a second PA 561, a fourth duplexer 563, and/or an LO 610. The RF circuit 600 may be implemented similarly to or substantially the same as an RF circuit 600 described in FIG. 6, so a detailed description thereof will be omitted herein.

According to one or more embodiments, the processor 120 may include an application processor and/or a communication processor. According to one or more embodiments, the electronic device 101 may further include at least one component among components illustrated in FIG. 1. According to one or more embodiments, the RFIC 211, the RFFE 213, and/or the RF circuit 600 may form at least a portion of a wireless communication module 192 in FIG. 1.

According to one or more embodiments, the processor 120 may be implemented similarly to or substantially the same as a processor 120 described in FIG. 6, so a detailed description thereof will be omitted herein. In FIG. 8, a transmitting operation and a receiving operation in a case that the electronic device 101 operates in a second mode be implemented similarly to or substantially the same as a transmitting operation and a receiving operation in a case that an electronic device 101 operates in a second mode described in FIG.

6, so a detailed description thereof will be omitted herein. In FIG. 8, a transmitting operation and a receiving operation in a case that the electronic device 101 operates in a first mode be implemented similarly to or substantially the same as a transmitting operation and a receiving operation in a case that an electronic device 101 operates in a first mode described in FIG. 6, so a detailed description thereof will be omitted herein.

A structure of the electronic device 101 illustrated in FIG. 8 may be different from a structure of an electronic device 101 illustrated in FIG. 6 only in that it additionally includes the fourth switch 710 and/or the fifth switch 720, and this will be described in detail as follows.

In a case of the RFIC 211, the number of pins which may be supported may be limited. However, the electronic device 101 is evolving into a structure which supports multi-band, so a case may occur that the number of pins which may be supported in the RFIC 211 is insufficient. Therefore, FIG. 8 proposes a structure in which the RFFE 213 and the RF circuit 600 may share the pins of the RFIC 211.

In one or more embodiments, the fourth switch 710 and the fifth switch 720 may perform a switching operation under the control of the processor 120.

In one or more embodiments, the fourth switch 710 may be a switch used for sharing a first transmission pin (e.g., #1_Tx), and may perform a switching operation so that a signal in the fourth frequency band is transferred to the first PA 511, or perform a switching operation so that a first signal in the second frequency band is transferred to the first mixer 555, under the control of the processor 120.

In one or more embodiments, the fifth switch 720 may be a switch used for sharing a third reception pin (e.g., #1_Rx3), and may perform a switching operation so that the signal transferred from the third LNA 529 is inputted to the RFIC 211, or perform a switching operation so that the signal transferred from the first filter 551 is inputted to the RFIC 211, under the control of the processor 120.

A case that the first signal is a signal corresponding to the 2.1 GHz band and the second signal is a frequency signal corresponding to the 1.65 GHz band has been described as one or more examples in FIG. 8, however, a frequency band corresponding to the first signal may not necessarily need to be the 2.1 GHz band, and a frequency band corresponding to the second signal may not necessarily need to be the 1.65 GHz band. In the first frequency band (e.g., a B31 band), a frequency band of 452.5 MHz to 457.5 MHz is used as a transmission frequency band and a frequency band of 462.5 MHz to 467.5 MHz is used as a reception frequency band, so a frequency signal corresponding to any frequency band may be used as the first signal and the second signal if only a transmission frequency band in the B31 band may be generated.

As described in FIG. 8, the electronic device 101 may support the B31 band based on the first RF signal and the second RF signal without using a separate external electronic device, so an improvement may be achieved in terms of securing portability and security.

According to one or more embodiments of the disclosure, an electronic device (101) may include at least one antenna (215; 580), a radio frequency integrated circuit (RFIC) (211), a radio frequency front end (RFFE) (213) including a first power amplifier (PA) (511) connected to the RFIC and the at least one antenna, a radio frequency (RF) circuit (550; 600) including a first mixer (555) connected to the RFIC, and a second PA (561) connected to the first mixer and the at least one antenna, at least one processor (120), and memory (130) storing instructions.

According to one or more embodiments of the disclosure, the instructions, when executed by the at least one processor, may cause the electronic device to switch to a first mode when identifying that a condition for activating the first mode for transmitting/receiving a signal in a first frequency band is satisfied.

According to one or more embodiments of the disclosure, the instructions, when executed by the at least one processor, may cause the electronic device to convert, via the RFIC in the first mode, first data to be transmitted to an external electronic device (102; 104; 108) into a first signal in a second frequency band.

According to one or more embodiments of the disclosure, the instructions, when executed by the at least one processor, may cause the electronic device to mix the first signal with a second signal in a third frequency band via the first mixer to generate a third signal in the first frequency band.

According to one or more embodiments of the disclosure, the instructions, when executed by the at least one processor, may cause the electronic device to amplify, via the second PA, the third signal based on a first gain to generate a fourth signal, and transmit the fourth signal to the external electronic device via the at least one antenna.

According to one or more embodiments of the disclosure, the RF circuit may further include a second mixer (553) connected to the RFIC, and a low noise amplifier (LNA) (559) connected to the second mixer and the at least one antenna.

According to one or more embodiments of the disclosure, the instructions, when executed by the at least one processor, may cause the electronic device to perform, via the LNA, a low-noise amplification operation on a fifth signal in the first frequency band received from the external electronic device via the at least one antenna to generate a sixth signal.

According to one or more embodiments of the disclosure, the instructions, when executed by the at least one processor, may cause the electronic device to mix the sixth signal with the second signal via the second mixer to generate a seventh signal in the second frequency band, and transfer the seventh signal to the RFIC.

According to one or more embodiments of the disclosure, the instructions, when executed by the at least one processor, may cause the electronic device to generate the second signal via the RFIC and transfer the second signal to at least one of the first mixer or the second mixer.

According to one or more embodiments of the disclosure, the RF circuit may further include a local oscillator (LO) which generates the second signal and transfers the second signal to at least one of the first mixer or the second mixer.

According to one or more embodiments of the disclosure, the RF circuit may further include a duplexer connected to the at least one antenna, the LNA, and the second PA.

According to one or more embodiments of the disclosure, the RF circuit may further include a first filter which is connected to the first mixer and the second PA, and performs a filtering operation on the third signal to generate an eighth signal and transfers the eighth signal to the second PA.

According to one or more embodiments of the disclosure, the RF circuit may further include a second filter which is connected to the RFIC and the LNA, and performs a filtering operation on the seventh signal to generate a ninth signal and transfers the ninth signal to the RFIC.

According to one or more embodiments of the disclosure, the first frequency band may be a frequency band lower than the second frequency band and the third frequency band.

According to one or more embodiments of the disclosure, the second frequency band may be a frequency band higher than the third frequency band.

According to one or more embodiments of the disclosure, the first frequency band may be a frequency band ranging from about 450 MHz to 500 MHz.

According to one or more embodiments of the disclosure, the second frequency band may be a frequency band ranging from about 1.8 GHz to 2.2 GHz.

According to one or more embodiments of the disclosure, the third frequency band may be a frequency band ranging from about 1.5 GHz to 18 GHz.

According to one or more embodiments of the disclosure, the instructions, when executed by the at least one processor, may cause the electronic device to switch to a second mode for transmitting/receiving a signal in a fourth frequency band when identifying that a condition for deactivating the first mode is satisfied.

According to one or more embodiments of the disclosure, the instructions, when executed by the at least one processor, may cause the electronic device to convert, via the RFIC in the second mode, second data to be transmitted to the external electronic device into a tenth signal in the fourth frequency band.

According to one or more embodiments of the disclosure, the instructions, when executed by the at least one processor, may cause the electronic device to amplify the tenth signal based on a second gain via the first PA to generate an eleventh signal and transmit the eleventh signal to the external electronic device via the at least one antenna.

According to one or more embodiments of the disclosure, the first frequency band may be a frequency band lower than the second frequency band and the third frequency band.

According to one or more embodiments of the disclosure, the second frequency band may be a frequency band higher than the third frequency band.

According to one or more embodiments of the disclosure, the fourth frequency band may be a frequency band different from at least one of the first frequency band, the second frequency band, or the third frequency band.

According to one or more embodiments of the disclosure, the first frequency band may be a frequency band ranging from about 450 MHz to 500 MHz.

According to one or more embodiments of the disclosure, the second frequency band may be a frequency band ranging from about 1.8 GHz to 2.2 GHz.

According to one or more embodiments of the disclosure, the third frequency band may be a frequency band ranging from about 1.5 GHz to 18 GHz.

According to one or more embodiments of the disclosure, the fourth frequency band may be a frequency band different from at least one of the first frequency band, the second frequency band, or the third frequency band.

According to one or more embodiments of the disclosure, the electronic device may further include a first switch connected to the RFIC, the first PA, and the first mixer.

According to one or more embodiments of the disclosure, the instructions, when executed by the at least one processor, may cause the electronic device to transfer the first RF signal to the first mixer via the first switch.

According to one or more embodiments of the disclosure, the condition for activating the first mode may include at least one of a condition under which an application using the first frequency band is executed, or a condition under which a key or a button signal corresponding to a user input indicating use of the first frequency band is inputted.

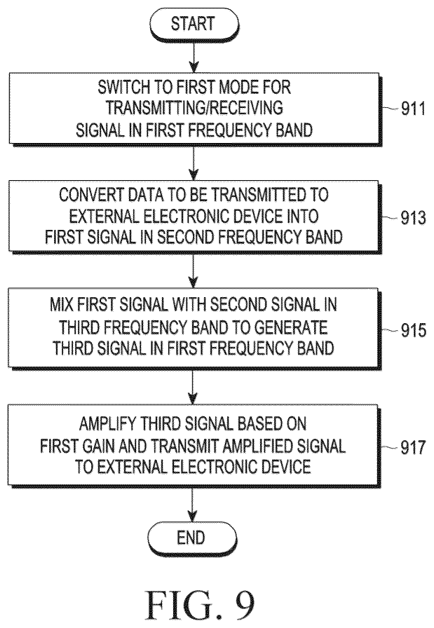

FIG. 9 is a flowchart illustrating an operating method of an electronic device according to one or more embodiments.

Referring to FIG. 9, an electronic device (e.g., an electronic device 101 in FIG. 1, 2, 3, 4, 5, 6, 7, or 8) (e.g., a processor 120 in FIG. 1, 2, 3, 4, 5, 6, 7, or 8) (e.g., a smart phone) may identify that a condition for activating a first mode for transmitting/receiving a signal in a first frequency band is satisfied in operation 911. In one or more embodiments, the first mode may be a mode in which the first frequency band (e.g., a B31 band or a 450 MHz band) is activated, and an RF circuit (e.g., an RF circuit 550 in FIG. 5 or 7, or an RF circuit 600 in FIG. 6 or 8) associated with the first frequency band (e.g., the B31 band or the 450 MHz band) is activated. In one or more embodiments, the first frequency band may be a frequency band ranging from about 450 MHz to 500 MHz. For example, the first frequency band may be a 450 MHz band. In one or more embodiments, there may be various conditions for activating the first mode, and the various conditions may include a condition under which a set application is executed and/or a condition under which a set key (e.g., button) signal is inputted. The first mode and the various conditions for activating the first mode have been described in FIGS. 5 to 8, so a detailed description thereof will be omitted herein. The electronic device, which identifies that the condition for activating the first mode is satisfied, may switch to the first mode in operation 911.

The electronic device, which switches to the first mode, may convert data (e.g., first data) to be transmitted to an external electronic device (e.g., an electronic device 102 or an electronic device 104 in FIG. 1, or a server 108 in FIG. 1) into a first signal in a second frequency band via an RFIC (e.g., a first RFIC 211 in FIG. 2 or 4, or an RFIC 211 in FIG. 5, 6, 7, or 8) in operation 913. In one or more embodiments, the second frequency band may be a frequency band ranging from about 1.8 GHz to 2.2 GHz. In one or more embodiments, the first frequency band may be a frequency band lower than the second frequency band. For example, the second frequency band may be a 2.1 GHz band. The operation of converting the data to be transmitted to the external electronic device via the RFIC into the first signal in the second frequency band has been described in FIGS. 5 to 8, so a detailed description thereof will be omitted herein.

The electronic device, which converts the data to be transmitted to the external electronic device into the first signal in the second frequency band, may mix the first signal with a second signal in a third frequency band via a first mixer (e.g., a first mixer 555 in FIG. 5, 6, 7, or 8) included in the RF circuit connected to the RFIC to generate a third signal in the first frequency band in operation 915. In one or more embodiments, the first frequency band may be a frequency band lower than the second frequency band and the third frequency band, and the second frequency band may be a frequency band higher than the third frequency band. In one or more embodiments, the third frequency band may be a frequency band ranging from about 1.5 GHz to 18 GHz. For example, the third frequency band may be a 1.65 GHZ frequency band. The operation of mixing the first signal in the second frequency band with the second signal in the third frequency band via the first mixer to generate the third signal in the first frequency band has been described in FIGS. 5 to 8, so a detailed description thereof will be omitted herein.

In operation 917, the electronic device, which generates the third signal in the first frequency band by mixing the first signal with the second signal in the third frequency band, may amplify the third signal based on a set gain (e.g., a first gain) via a PA (e.g., a second PA 561 in FIG. 5, 6, 7, or 8) included in the RF circuit, and transmit an amplified signal to the external electronic device via at least one antenna (e.g., a first antenna 215 or a second antenna 580 in FIG. 5, 6, 7, or 8).

According to one or more embodiments of the disclosure, a method may include switching to a first mode when identifying that a condition for activating the first mode for transmitting/receiving a signal in a first frequency band is satisfied.

According to one or more embodiments of the disclosure, the method may include converting, via a radio frequency integrated circuit (RFIC) (211) in the first mode, data to be transmitted to an external electronic device (102; 104; 108) into a first signal in a second frequency band.

According to one or more embodiments of the disclosure, the method may include mixing the first signal with a second signal in a third frequency band via a first mixer (555) included in a radio frequency (RF) circuit (550; 600) connected to the RFIC to generate a third signal in the first frequency band.

According to one or more embodiments of the disclosure, the method may include amplifying, via a power amplifier (PA) (561) included in the RF circuit, the third signal based on a set gain to generate a fourth signal, and transmitting the fourth signal to the external electronic device via at least one antenna (215; 580).

According to one or more embodiments of the disclosure, the method may include performing, via a low noise amplifier (LNA) (559) included in the RF circuit, a low-noise amplification operation on a fifth signal in the first frequency band received from the external electronic device via the at least one antenna to generate a sixth signal.

According to one or more embodiments of the disclosure, the method may include mixing the sixth signal with the second signal via a second mixer which is included in the RF circuit and connected to the RFIC to generate a seventh signal in the second frequency band, and transferring the seventh signal to the RFIC.

According to one or more embodiments of the disclosure, the method may include generating the second signal via the RFIC, and transferring the second signal to at least one of the first mixer or the second mixer.

According to one or more embodiments of the disclosure, the method may include generating the second signal via a local oscillator (LO) included in the RF circuit, and transferring the second signal to at least one of the first mixer or the second mixer.

According to one or more embodiments of the disclosure, the first frequency band may be a frequency band lower than the second frequency band and the third frequency band.

According to one or more embodiments of the disclosure, the second frequency band may be a frequency band higher than the third frequency band.

According to one or more embodiments of the disclosure, the first frequency band may be a frequency band ranging from about 450 MHz to 500 MHz.

According to one or more embodiments of the disclosure, wherein the second frequency band may be a frequency band ranging from about 1.8 GHz to 2.2 GHz.

According to one or more embodiments of the disclosure, the third frequency band may be a frequency band ranging from about 1.5 GHz to 18 GHz.

According to one or more embodiments of the disclosure, a storage medium storing at least one computer-readable instruction may be provided.

According to one or more embodiments of the disclosure, the at least one instruction, when executed by at least one processor (120) of an electronic device (101), may cause the electronic device to perform at least one operation.

According to one or more embodiments of the disclosure, the at least one operation may include switching to a first mode when identifying that a condition for activating the first mode for transmitting/receiving a signal in a first frequency band is satisfied.

According to one or more embodiments of the disclosure, the at least one operation may include converting, via a radio frequency integrated circuit (RFIC) (211) in the first mode, data to be transmitted to an external electronic device (102; 104; 108) into a first signal in a second frequency band.

According to one or more embodiments of the disclosure, the at least one operation may include mixing the first signal with a second signal in a third frequency band via a first mixer (555) included in a radio frequency (RF) circuit (550; 600) connected to the RFIC to generate a third signal in the first frequency band.

According to one or more embodiments of the disclosure, the at least one operation may include amplifying, via a power amplifier (PA) (561) included in the RF circuit, the third signal based on a set gain to generate a fourth signal, and transmitting the fourth signal to the external electronic device via at least one antenna (215; 580).

According to an embodiment of the disclosure, the at least one operation may include performing, via a low noise amplifier (LNA) (559) included in the RF circuit, a low-noise amplification operation on a fifth signal in the first frequency band received from the external electronic device via the at least one antenna to generate a sixth signal.

According to one or more embodiments of the disclosure, the at least one operation may include mixing the sixth signal with the second signal via a second mixer which is included in the RF circuit and connected to the RFIC to generate a seventh signal in the second frequency band, and transferring the seventh signal to the RFIC.

According to one or more embodiments of the disclosure, the at least one operation may include generating the second signal via the RFIC, and transferring the second signal to at least one of the first mixer or the second mixer.

According to one or more embodiments of the disclosure, the at least one operation may include generating the second signal via a local oscillator (LO) included in the RF circuit, and transferring the second signal to at least one of the first mixer or the second mixer.

According to one or more embodiments of the disclosure, the first frequency band may be a frequency band lower than the second frequency band and the third frequency band.

According to one or more embodiments of the disclosure, the second frequency band may be a frequency band higher than the third frequency band.

According to one or more embodiments of the disclosure, the first frequency band may be a frequency band ranging from about 450 MHz to 500 MHz.

According to one or more embodiments of the disclosure, the second frequency band may be a frequency band ranging from about 1.8 GHz to 2.2 GHz.

According to one or more embodiments of the disclosure, the third frequency band may be a frequency band ranging from about 1.5 GHz to 18 GHz.

The technical problem sought to be achieved in this document may not be limited to the technical problem mentioned above, and other technical problems not mentioned may be clearly understood by those skilled in the art of this document from the description below.

The effects that may be obtained from the disclosure may not be limited to the effects mentioned above, and other effects not mentioned may be clearly understood by those skilled in the art from the description below.

While certain embodiments of the disclosure has been particularly shown and described, it will be understood that various changes in form and details may be made therein without departing from the spirit and scope of the following claims.

What is claimed is:

1. An electronic device comprising:
at least one antenna;
a radio frequency integrated circuit (RFIC);
a radio frequency front end (RFFE) comprising a first power amplifier (PA) connected to the RFIC and the at least one antenna;
a radio frequency (RF) circuit comprising a first mixer connected to the RFIC, and a second PA connected to the first mixer and the at least one antenna;
at least one processor; and
memory storing instructions that, when executed by the at least one processor, cause the electronic device to:
switch to a first mode based on identifying that a condition for activating the first mode for transmitting and receiving a signal in a first frequency band is satisfied;
convert, using the RFIC in the first mode, first data to be transmitted to an external electronic device into a first signal in a second frequency band;
mix the first signal with a second signal in a third frequency band using the first mixer to generate a third signal in the first frequency band; and
amplify, using the second PA, the third signal based on a first gain to generate a fourth signal, and transmit the fourth signal to the external electronic device using the at least one antenna.

2. The electronic device of claim 1, wherein the RF circuit further comprises:
a second mixer connected to the RFIC; and
a low noise amplifier (LNA) connected to the second mixer and the at least one antenna,
wherein the instructions, when executed by the at least one processor, cause the electronic device to:
perform, using the LNA, a low-noise amplification operation on a fifth signal in the first frequency band received from the external electronic device using the at least one antenna to generate a sixth signal; and
mix the sixth signal with the second signal using the second mixer to generate a seventh signal in the second frequency band, and transfer the seventh signal to the RFIC.

3. The electronic device of claim 2, wherein the instructions, when executed by the at least one processor, cause the electronic device to:
generate the second signal using the RFIC and transfer the second signal to at least one of the first mixer or the second mixer.

4. The electronic device of claim 2, wherein the RF circuit further comprises:
a local oscillator (LO) configured to generate the second signal and transfer the second signal to at least one of the first mixer or the second mixer.

5. The electronic device of claim 1, wherein the RF circuit further comprises:
a duplexer connected to the at least one antenna, the LNA, and the second PA.

6. The electronic device of claim 1, wherein the RF circuit further comprises:
a first filter which is connected to the first mixer and the second PA, and configured to perform a filtering operation on the third signal to generate an eighth signal and transfer the eighth signal to the second PA.

7. The electronic device of claim 2, wherein the RF circuit further comprises:
a second filter which is connected to the RFIC and the LNA, and configured to perform a filtering operation on the seventh signal to generate a ninth signal and transfer the ninth signal to the RFIC.

8. The electronic device of claim 1, wherein the first frequency band is lower than the second frequency band and the third frequency band, and
wherein the second frequency band is higher than the third frequency band.

9. The electronic device of claim 1, wherein the first frequency band ranges from about 450 MHz to 500 MHZ,
wherein the second frequency band ranges from about 1.8 GHz to 2.2 GHZ, and
wherein the third frequency band ranges from about 1.5 GHz to 18 GHz.

10. The electronic device of claim 1, wherein the instructions, when executed by the at least one processor, cause the electronic device to:
switch to a second mode for transmitting and receiving a signal in a fourth frequency band based on identifying that a condition for deactivating the first mode is satisfied;
convert, using the RFIC in the second mode, second data to be transmitted to the external electronic device into a tenth signal in the fourth frequency band; and
amplify the tenth signal based on a second gain using the first PA to generate an eleventh signal and transmit the eleventh signal to the external electronic device using the at least one antenna.

11. The electronic device of claim 10, wherein the first frequency band is lower than the second frequency band and the third frequency band,
wherein the second frequency band is higher than the third frequency band, and
wherein the fourth frequency band is different from at least one of the first frequency band, the second frequency band, or the third frequency band.

12. The electronic device of claim 10, wherein the first frequency band ranges from about 450 MHz to 500 MHz,
wherein the second frequency band ranges from about 1.8 GHz to 2.2 GHZ,
wherein the third frequency band ranges from about 1.5 GHz to 18 GHZ, and
wherein the fourth frequency band is different from at least one of the first frequency band, the second frequency band, or the third frequency band.

13. The electronic device of claim 1, further comprising:
a first switch connected to the RFIC, the first PA, and the first mixer,
wherein the instructions, when executed by the at least one processor, cause the electronic device to:
transfer the first signal to the first mixer using the first switch.

14. The electronic device of claim 1, wherein the condition for activating the first mode comprises at least one of:
an application using the first frequency band being executed, or a key or a button signal corresponding to a user input indicating use of the first frequency band being inputted.

15. A method, comprising:
switching to a first mode based on identifying that a condition for activating the first mode for transmitting and receiving a signal in a first frequency band is satisfied;
converting, using a radio frequency integrated circuit (RFIC) in the first mode, data to be transmitted to an external electronic device into a first signal in a second frequency band;
mixing the first signal with a second signal in a third frequency band using a first mixer in a radio frequency (RF) circuit connected to the RFIC to generate a third signal in the first frequency band; and
amplifying, using a power amplifier (PA) in the RF circuit, the third signal based on a set gain to generate a fourth signal, and transmitting the fourth signal to the external electronic device using at least one antenna.

16. The method of claim 15, further comprising:
performing, using a low noise amplifier (LNA) in the RF circuit, a low-noise amplification operation on a fifth signal in the first frequency band received from the external electronic device using the at least one antenna to generate a sixth signal; and
mixing the sixth signal with the second signal using a second mixer in the RF circuit and connected to the RFIC to generate a seventh signal in the second frequency band, and transferring the seventh signal to the RFIC.

17. The method of claim 16, further comprising:
generating the second signal using the RFIC, and transferring the second signal to at least one of the first mixer or the second mixer.

18. The method of claim 16, further comprising:
generating the second signal using a local oscillator (LO) in the RF circuit, and transferring the second signal to at least one of the first mixer or the second mixer.

19. The method of claim 15, wherein the first frequency band is lower than the second frequency band and the third frequency band, and
wherein the second frequency band is higher than the third frequency band.

20. The method of claim 15, wherein the first frequency band ranges from about 450 MHz to 500 MHz,
wherein the second frequency band ranges from about 1.8 GHz to 2.2 GHZ, and
wherein the third frequency band ranges from about 1.5 GHz to 18 GHz.
